(19) United States
(12) Patent Application Publication
(10) Pub. No.: US 2007/0240822 A1
(43) Pub. Date: Oct. 18, 2007

(54) Binder System Containing Aminoplast Resins, at Least One Acetal of Partially or Fully Saponified Polyvinylester and Aldehyde and Acid

(75) Inventors: Stephan Weinkotz, Neustadt (DE); Eberhard Pfutze, Ludwigshafen (DE); Claus Fueger, Lemberg (DE)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 11/573,468

(22) PCT Filed: Jul. 30, 2005
(86) PCT No.: PCT/EP05/08293

§ 371 Date: Feb. 9, 2007

(30) Foreign Application Priority Data
Aug. 9, 2004 (DE) 102004038785.0

(51) Int. Cl. C09J 161/32

(52) U.S. Cl. 156/327; 524/500

(57) ABSTRACT

The present invention relates to a binder system comprising aminoplast resins, at least one acetal of partly or completely hydrolyzed polyvinyl ester and aldehyde and acid. The invention furthermore relates to a process for the production of glued materials using said binder system, and wood-base materials which comprise this binder system.

The present invention relates to a binder system comprising aminoplast resins, at least one acetal of partly or completely hydrolyzed polyvinyl ester and aldehyde and acid. The invention furthermore relates to a process for the production of glued materials using said binder system and wood-base materials which comprise this binder system.

The prior art describes a wide range of proposals for optimizing binder systems in order for example, to improve their shelf life, formaldehyde emission, moldability, surface quality, transparency, UV stability and gloss.

For these purposes, very different additives are added to the binder system, i.e. the glue comprising aminoplast resin or the curing agent comprising at least one acid.

EP-A 501 174 discloses a curing agent for urea/formaldehyde binders based on an aqueous emulsion of polyvinyl acetate having postcrosslinkable groups, an ammonium salt and urea.

WO 02/68178 describes a curing agent for aminoplast resins comprising partly functionalized polyvinyl acetate, an acid, an acidic salt and/or an acid-generating salt, and conventional additives. A process in which the curing agent and the adhesive are applied separately, then combined, and cured under pressure is furthermore disclosed.

WO 01/70898 describes a binder system comprising an etherified amino resin, partly functionalized polyvinyl acetate, organic acids and polyvinyl alcohol.

In spite of the wide range of binder systems, which are described in the prior art, there is still a need for improvement with regard to the gluing properties and the shelf life.

The object of the present invention was to provide improved binder systems based on aminoplast resins.

Surprisingly, a binder system comprising
(a) aminoplast resin
(b) at least one acetal of partly or completely hydrolyzed polyvinyl ester and aldehyde
(c) acid, an acidic salt and/or an acid-generating salt
   which has improved gluing properties was found. Furthermore, a curing agent comprising acetal(s) of partly or completely hydrolyzed polyvinyl ester and aldehyde, which has a long shelf life, was found.

The aminoplast resin used in the binder system according to the invention is typically a urea/formaldehyde, a melamine/urea/formaldehyde or a melamine/formaldehyde resin or mixtures thereof. These resins may have been partly or completely etherified with alcohols, in particular methanol. Etherified and unetherified melamine/urea/formaldehyde and melamine/formaldehyde resins or mixtures thereof are preferably used.

The degree of etherification of the aminoplast resin mixture comprising etherified and unetherified aminoplast resins is advantageously from 1 to 95%. The degree of etherification is preferably from 10 to 70%, in particular from 20 to 65%. The degree of etherification corresponds to the ratio of the number of etherified methylol groups to the number of the etherified and the unetherified methylol groups multiplied by 100.

The proportion of the etherified aminoplast resins is advantageously from 20 to 80% by weight, based on the aminoplast resin mixture (component a)), in particular from 40 to 60% by weight.

Advantageously, the aminoplast resin is prepared separately from the curing agent Preferably, the aminoplast resin does not come into contact with a curing agent until after the condensation reaction. Components of the curing agent are as a rule therefore not incorporated into the aminoplast resin. In particular, the aminoplast resin does not come into contact with the curing agent until the gluing process.

In the binder system according to the invention, the aminoplast resin is preferably present in an amount of from 5 to 70% by weight of solid (solids content at 120° C./2 h), based on the total weight of the binder system (solids including water). The aminoplast resin is preferably present in an amount of from 15 to 65% by weight, in particular from 25 to 60% by weight. The solids content of the aminoplast resin is as a rule from 50 to 80%, preferably from 60 to 75%.

The invention furthermore relates to a curing agent for aminoplast resins, comprising acetal(s) of partly or completely hydrolyzed polyvinyl esters and aldehydes. As a rule, the components (b) and (c) constitute the curing agent according to the invention.

One or more acetals of partly or completely hydrolyzed polyvinyl esters and aldehydes are used as component (b). One or more branched or straight-chain C₁- to C₁₀-aldehydes, preferably C₁- to C₄-aldehydes, in particular formaldehyde, are advantageously used as the aldehyde. C₁- to C₄-polyvinyl ester, preferably polyvinyl acetate, is advantageously used as the partly or completely hydrolyzed polyvinyl ester. Mixtures of hydrolyzed polyvinyl esters may also be used. The degree of hydrolysis is advantageously above 50%, preferably from 70 to 100%, in particular from 80 to 100%. The partly or completely hydrolyzed polyvinyl ester advantageously has an average molecular weight of from 10 000 to 500 000, in particular from 20 000 to 250 000.

After the reaction of partly or completely hydrolyzed polyvinyl ester and aldehyde to give the acetal, advantageously from 2 to 80% of the OH groups of the partly or completely hydrolyzed polyvinyl ester have been acetalated, preferably from 5 to 60%, in particular from 10 to 40%. At a degree of hydrolysis of more than 80 percent, preferably from 2 to 50% of the OH groups of the polyvinyl ester hydrolyzed to over 80 percent have been acetalated, preferably from 10 to 40%, in particular from 20 to 30%.

The acetalation reaction is a reversible process, the equilibrium being on the side of the acetal (cf. N. Nakamura, K. Suzuki, J. Polymer Sci., Part A, 1996, 34, 3319-3328 and K. Fijii, et al., Polymer Letters 1963, 1, 693-696). The prior art (for example, I. Pollers et al., Macromolecules 1996, 29, 5875-5881) describes various methods for synthesizing polyvinyl formal. These different preparation methods may lead to a different distribution of the acetals in the polyvinyl formal. In the “heterogeneous method”, blockwise acetatation occurs to a pronounced extent, a random distribution tending to be present in the “precipitation method”.

The acetals used as component (b) can be prepared with the aid of all methods known to a person skilled in the art.

For example, the copolymer can be prepared by adding acid and then aldehyde to the hydrolyzed polyvinyl ester dissolved in water and heating this mixture to 50 to 100° C., preferably 70 to 100° C., in particular 80 to 90° C. The reaction mixture is kept at this temperature for a duration of, typically, from 30 minutes to 6 hours. When formaldehyde is used, it is usually employed in the form of concentrated aqueous solutions, for example as 20 to 60 percent strength by weight aqueous solution, preferably as 40 to 55 percent strength by weight solution.

The distribution of the acetal groups is preferably random. The acetal formed advantageously has a viscosity at 20° C. of from 500 to 10 000 mPa·s (10% strength solution in water).

In the binder system according to the invention, the component (b) is present in an amount of from 0.1 to 15% by weight, based on the total weight of the binder. Preferably, the component (b) is present in an amount of from 0.5 to 10% by weight, in particular from 1 to 6% by weight.

The binder system according to the invention comprises at least one acid, one acidic salt and/or one acid-generating salt (component (c)). The choice of the acid or of the salt depends on the characteristics of the curing agent, for example the rate at which the curing after the mixing of the aminoplast resin and the curing agent is to take place.

Acids typically used are organic acids, such as, for example, maleic acid, citric acid or formic acid, or inorganic acids, such as, for example, phosphoric acid or sulfamic acid, or mixtures thereof. Organic acids are preferred, in particular formic acid.

Acidic salts are understood as meaning those which form an acidic solution in water. Aluminum phosphate, aluminum nitrate, aluminum sulfate or aluminum chloride or mixtures thereof are advantageously used.

An acid-generating salt is understood as meaning those salts which generate an acid by reaction with a component of the binder system. Ammonium salts, such as, for example, ammonium phosphate, ammonium sulfate and/or ammonium chloride, are advantageously used.

In the binder system according to the invention, the component (c) is present in an amount of from 0.5 to 30% by weight, based on the total weight of the binder system. The component (c) is preferably present in an amount of from 1 to 20% by weight, in particular from 1.5 to 15% by weight.

The component (c) can advantageously be present partly or completely in the preparation of the acetal.

Furthermore, the curing agent may additionally comprise, as component (d), a polymer in the form of a dispersion and/or as a water-soluble polymer solution and/or mixtures of different polymer dispersions or aqueous polymer solutions.

The polymer is typically a homopolymer or a copolymer prepared from one or more ethylenically unsaturated monomers. Examples of advantageous ethylenically unsaturated monomers are vinyl monomers, such as vinyl esters, for example vinyl acetate, vinyl propionate, vinyl butyrate and comonomers thereof; polyacrylates, such as, for example, alkyl esters of acrylic or methacrylic acids, such as methyl acrylate, methyl methacrylate, ethyl acrylate, n-butyl acrylate, etc.; butadiene-styrene and derivatives, such as, for example, carboxylated butadiene-styrene; substituted or unsubstituted mono- and dialkyl esters of the alpha, beta-unsaturated (di)carboxylic acids, such as, for example, substituted and unsubstituted mono- and dibutyl and mono- and diethyl esters of maleic acid or the corresponding esters of fumaric acid, citric acid or itaconic acid, crotonic acid, (meth)acrylic acid; polyurethanes, polyvinyl alcohol. Polyvinyl acetates and vinyl acetate copolymers are preferred, in particular ethylene/vinyl acetate copolymers. The polymer advantageously comprises at least 50% by weight, based on the total weight of the monomer, of vinyl acetate.

The polymer dispersion may comprise polymers having postcrosslinkable groups. These postcrosslinkable groups can be introduced into the polymer via copolymerization, by reacting one or more ethylenically unsaturated monomers with at least one monomer comprising at least one postcrosslinkable group. The polymer preferably comprises from 0 to 10% by weight of monomers having postcrosslinkable groups, preferably from 0 to 5% by weight. Mixtures of polymers having postcrosslinkable groups and polymers without postcrosslinkable groups are furthermore preferred, in particular mixtures with homo- or copolymers of vinyl acetate. Postcrosslinkable groups are understood as meaning those which have a lower reactivity than unsaturated groups and therefore do not participate in the first polymerization reaction but react only under certain conditions, for example acidic conditions, with other reactive groups, advantageously on the copolymer and/or on the aminoplast resin.

Suitable postcrosslinkable groups are advantageously N-functional groups, those stated in WO 01/70898 and WO 02/068178 being mentioned here by way of example, Amides, N-alkylolamides and N-alkoxymethylamides are particularly suitable.

In the binder system according to the invention, the polymer, or the polymer blend, of component (d) is present in an amount of from 0 to 30% by weight, based on the total weight of the binder system. The polymer is preferably present in an amount of from 1 to 25% by weight, in particular from 3 to 20% by weight.

The component (d) can advantageously be present partly or completely in the preparation of the acetal.

The binder system according to the invention can, if appropriate, comprise conventional additives (component (e)) in the aminoplast resin and/or in the curing agent (cf. for example M. Dunky, P. Niemz, Holzwerkstoffe und Leime, Technologie und Einflussfaktoren, Springer, 2002, pages 436-444, Chapter 2.7 “Zusatzstoffe”). These include fillers (cf. Zeppenfeld, Klebstoffe in der Holz- und Möbelindustrie, Buchverlag Leipzig, 1st edition), such as, for example, alkaline earth metal silicates, aluminum silicates such as kaolin, silica, pyrogenic and precipitated silicic acids, alkaline earth metal carbonates, alkaline earth metal sulfates, metal oxides, fibers, such as, for example, glass, mica or cellulose. Further additives are advantageously flours, starches, modified starch, modified cellulose, for example methylcellulose, carboxymethylcellulose or hydroxyethylcellulose, thickeners as mentioned in WO 02168178, dyes, formaldehyde scavengers, surfactants, antifoams, solvents, such as, for example, diethylene glycol, and further additives known to a person skilled in the art Kaolins, silicic acids, cellulose derivatives, glycols and surfactants are preferably used.

The component (e) may be present either in the curing agent or in the aminoplast or in both components; advantageously, the component (e) is present in an amount of from 0 to 20% by weight, preferably from 0 to 10% by weight, in the curing agent and from 0 to 20% by weight, preferably from 0 to 10% by weight, in the aminoplast. In the binder system according to the invention, the conventional additives are present in an amount of from 0 to 25% by weight, based on the total weight of the binder system. The conventional additives are preferably present in an amount of from 0 to 10% by weight, in particular from 0 to 5% by weight.

The curing agent usually has a pH of from 1 to 6.5, in particular from 1.3 to 3. The viscosity of the curing agent is preferably more than 300 mPa·s, particularly preferably more than 1000 mPa·s (at room temperature and a shear rate of 100 s⁻¹). It advantageously exhibits pseudoplastic behavior. The active substance content of the curing agent ((b)+(c)+if appropriate (d)+if appropriate (e)) is from 10 to 70% by weight, preferably from 20 to 55% by weight, the remaining proportion consisting of water.

The percentages by weight of components (a) to (e) stated for the binder system are based on the pure, nonaqueous starting materials. The stated amounts of the components (a) to (e) together with water sum to 100% by weight. The solids content or active substance content of the binder system is as a rule from 25 to 75% by weight, preferably from 40 to 65% by weight, the remaining proportion consisting of water. Although a liquid binder system is preferred, a pulverulent binder system is also possible.

The binder system according to the invention is particularly suitable for gluing materials. It can be prepared by mixing the components (a) with (b), (c) and, if appropriate, (d) and/or (e). The binder system is then applied to the wood to be glued.

The aminoplast resin [(a) and, if appropriate, (e)] is advantageously applied separately from the curing agent [(b), (c) and, if appropriate, (d) and/or (e)] to the material and is not mixed with said curing agent until the pressing.

However, the aminoplast resin can also be mixed with the component (b) and applied separately from the components (c) and, if appropriate, (d). Furthermore, the aminoplast resin can be mixed with the component (b) and applied separately from the components (b) and (c). In both cases, the component (e) may be present in all component mixtures.

The aminoplast resin is preferably applied separately from the curing agent comprising (b) and (c) and, if appropriate, (d), it being possible for the component (e) to be present in both mixtures.

The two components may each be applied in the form of strips, points, films and/or spray. The total amount applied is as a rule from 20 to 500 g/m², in particular from 250 to 450 g/m².

The binder system according to the invention is not limited to a special application but is advantageously used in the wood industry. The invention therefore relates to wood-base materials which comprise the binder according to the invention. The binder system is preferably used for the extensive gluing of wood, for example in parquet, hot roller laminations (films on, for example, particle boards), veneers, plywood, single-ply boards, multi-ply boards and formwork boards. In particular, the binder system is used for extensive gluing for load-bearing applications, for example in glued laminated wood, duo and trio beams (also see WO 02/068178 or EP-A 860 251).

In the context of this invention, the term “wood-base materials” to be understood as meaning materials which are produced by comminution of wood and subsequent assembly of the structural elements. Depending on the size and shape of the structural elements, a distinction is made between solid wood, veneer, particle, fiber and composite materials (cf. M. Dunky, P. Niemz, Holzwerkstoffe und Leime, Technologie und Einflussfaktoren, Springer, 2002, pages 3-8).

### EXAMPLES

Binder 1 (According to the Invention):

Glue: The glue used (component a)) was an aminoplast resin etherified with methanol and having a solids content of 70% (120° C., 2 h) and a degree of etherification of 33%.
Curing agent: The curing agent (components b) and c)) was prepared by reacting 13 parts of polyvinyl alcohol in 100 parts of water with 26.8 parts of formic acid (85% strength) and 3.3 parts of aqueous formaldehyde solution (40% strength). The solution was stirred for 4 h at 85° C. A commercial dispersion of a vinyl acetate/ethylene copolymer was added as component d).
   Binder 2 (Comparative Example Analogous to the Invention WO 01/70898):
Glue: The glue used (component (a)) was a commercial aminoplast resin etherified with methanol and having a solids content of 70% (120° C., 2 h) and a degree of etherification of 33%.
Curing agent The curing agent comprised 13 parts of unacetalated polyvinyl alcohol and 26.8 parts of formic acid (85% strength) in 103 parts of water, A commercial dispersion of a vinyl acetate/ethylene copolymer was used as component d).

The commercial dispersion of a vinyl acetate/ethylene copolymer was present in the curing agents in an amount such that the solids content of the dispersion was 20%, based on the mixture.

Shelf life of the curing agents consisting of the components b) to d):

TABLE 1
Shelf life

| | | Viscosity |
|---|---|---|
| | Initial | after 120 days |
| Curing agent | viscosity [mPa · s] | [mPa · s] |
| Curing agent of binder 1 | 2837 | 2958 |
| Curing agent of binder 2 | 1500 | 3635 |

Testing of Performance Characteristics:

The glue and the curing agent of binders 1 and 2 were applied separately to pine lamellae, the curing agent being applied in the form of strings and the glue in the form of a film. The total amount applied was 400 g/m² and the weight ratio of glue to curing agent was 1:1. Glued laminated wood was produced from the lamellae. The press time was 2.5 h at 25° C. and the pressure applied was 0.8 N/mm².

15 min after opening the press, block shear tests were carried out on cross-sectional test specimens (5 cm×5 cm) (EN 386). Furthermore, a delamination test according to EN 391-B was carried out after 3 days. The following results were obtained.

TABLE 2
Results of testing of the performance characteristics

| | Shear strength [N/mm²] | Delamination [%] |
|---|---|---|
| Binder | (EN 386) | (EN 391-B) |
| Binder 1 | 6.3 | 1.6 |
| Binder 2 | 4.7 | 7.2 |

1-27. (canceled)

28. A binder system comprising
(a) from 15 to 70% by weight of aminoplast resin,
(b) from 0.1 to 15% by weight of at least one acetal of partly or completely hydrolyzed polyvinyl ester and formaldehyde,
(c) from 0.5 to 30% by weight of acid, an acidic salt and/or an acid-generating salt,
(d) from 0 to 30% by weight of polymer(s) in the form of a dispersion or as a water-soluble polymer solution, and
(e) from 0 to 25% by weight of additives, based on the total weight of the binder system.

29. The binder system according to claim 28, wherein component (b) is acetals of partly or completely hydrolyzed polyvinyl acetate and formaldehyde.

30. The binder system according to claim 28, wherein the degree of hydrolysis of the polyvinyl ester is greater than 50 percent.

31. The binder system according to claim 28, wherein the partly or completely hydrolyzed polyvinyl ester has an average molecular weight of from 10 000 to 500 000.

32. The binder system according to claim 28, wherein, in the acetal, from 2 to 80 percent of the OH groups of the partly or completely hydrolyzed polyvinyl ester have been acetalated.

33. The binder system according to claim 28, wherein a 10 percent strength by weight solution of the acetal in water has a viscosity of from 500 to 10 000 mPa·s.

34. The binder system according claim 28, wherein the components (a) to (e) are present in the following amounts, based on the total weight of the binder system:
(a) from 25 to 70% by weight,
(b) from 0.5 to 10% by weight,
(c) from 1 to 20% by weight,
(d) from 1 to 25% by weight,
(e) from 0 to 10% by weight,
based on the total weight of the binder system.

35. The binder system according to claim 28, wherein said aminoplast resin is an etherified or unetherified melamine/urea/formaldehyde resin, an etherified or unetherified melamine/formaldehyde resin or a mixture thereof.

36. Aminoplast resins, comprising acetal(s) of partly or completely hydrolyzed polyvinyl esters and formaldehyde and curing agents.

37. The resins according to claim 36, wherein the aminoplast resin is an etherified aminoplast resin or a mixture of an etherified and an unetherified aminoplast resin.

38. A process for gluing wood which comprises applying a binder system to wood wherein the binder system comprises
(a) aminoplast resin
(b) at least one acetal of partly or completely hydrolyzed polyvinyl ester and aldehyde
(c) acid, an acidic salt and/or an acid-generating salt.

39. A wood-base material, comprising a binder according to claim 28.
